(19) United States
(12) Patent Application Publication
(10) Pub. No.: US 2011/0020646 A1
(43) Pub. Date: Jan. 27, 2011

(54) NANODIAMONDS AND DIAMOND-LIKE PARTICLES FROM CARBONAEOUS MATERIAL

(76) Inventors: Allen J. West, Dewey, AZ (US); James Kennett, Goleta, CA (US)

Correspondence Address: BERLINER & ASSOCIATES, 555 WEST FIFTH STREET, 31ST FLOOR, LOS ANGELES, CA, 90013, US

(21) Appl. No.: 12/864,077

(22) PCT Filed: Jan. 22, 2009
(86) PCT No.: PCT/US09/31731

§ 371 Date: Sep. 16, 2010

Related U.S. Application Data
(60) Provisional application No. 61/062,350, filed on Jan. 25, 2008.

(51) Int. Cl. D02G 3/16; C01B 31/06; C01B 31/02; D01F 9/12; B82Y 30/00

(52) U.S. Cl. 428/401; 423/446; 423/445 B; 423/447.1; 423/445 R; 977/773; 977/734; 977/743

(57) ABSTRACT

A method for producing a nanodiamond (n-diamond, p-diamond, i-carbon) in which a nanodiamond is removed from an activated carbon containing the nanodiamond. The activated carbon is prepared by carbonizing and/or activating a carbonaceous feedstock while restricting the presence of oxygen sufficiently to result in the formation of nanodiamonds embedded in carbon. The nanodiamonds can be separated and purified from the activated carbon, and can be concentrated by treatment of the activated carbon with an oxidizing agent. Also provided is a method for producing a nanodiamond, and particularly a nanodiamond fiber, by mixing a carbon source, a metal and an acid under conditions which result in nanodiamond formation. Nanodiamond fibers up to 2000 nanometers or more can be produced. The nanodiamond fibers can be woven or used to provide structural reinforcement for various materials.

### CROSS-REFERENCE TO RELATED APPLICATIONS

This application claims the benefit of U.S. Provisional Application 61/062,350, filed on Jan. 25, 2008, which is incorporated by reference herein.

### STATEMENT REGARDING FEDERALLY SPONSORED RESEARCH OR DEVELOPMENT

This invention was made with Government support under Grant No. SGER grant ATM-0713769 from the U.S. National Science Foundation. The Government has certain rights in this invention.

### BACKGROUND

1. Field of the Invention

The invention relates to nanodiamonds and diamond-like particles from carbonaceous material.

2. Related Art

Natural diamond is produced in high pressure and high temperature igneous shafts (kimberlites), and the scarcity and cost of natural diamond have stimulated synthetic diamond research for over 100 years. Diamond synthesis typically requires high energy inputs, as diamond is not the thermodynamically stable form of carbon at ambient conditions. Generally, diamond is synthesized at high pressure (about 1-10 GPa) and at high temperatures (Th>2000 K). Synthetic diamond is currently produced via either chemical vapor deposition (CVD) or explosive detonation of TNT. However, because these methods of producing diamonds involve very high pressure and temperatures or large energy expenditures, their synthesis is difficult.

Diamonds are valued for superior hardness and durability and thus have uses in many industries, such as
i. GRINDING AND POLISHING: eyeglass lenses, contact lenses, laser components, ball bearings, ceramics, precious stones, mirrors, computer discs, and constituents of grinding wheels.
ii. MISCELLANEOUS: lubricant additive, reinforcing fillers, nanoglues, oral dentistry, biologically active carriers, magnetic media constituents, and surfacing for drill bits and cutting tools.

Currently, most nanodiamonds are made by explosive detonation of TNT, and some are made by chemical vapor deposition (CVD). In Lueking et al. (U.S. Patent Application Publication 20070148080, hereby incorporated by reference), a method is described for synthesizing nanocrystalline diamond, diamond-like carbon and bucky diamond under lower pressure by subjecting a carbon source, such as coal, to the addition of energy, such as high energy reactive milling, producing a milling product enriched in hydrogenated tetrahedral amorphous diamond-like carbon compared to the coal. The milling product is treated with heat, acid and/or base to produce nanocrystalline diamond and/or crystalline diamond-like carbon.

### SUMMARY

Diamonds can be used in many ways that exploit their hardness and durability. Additional methods of preparing diamonds, especially at low pressures and low-to-moderate temperatures, and without the need for milling or other high energy input, are therefore highly desirable. Such methods would allow diamonds to be produced economically under less harsh conditions.

In one aspect, a method for producing a nanodiamond is provided. The method includes removing a nanodiamond from an activated carbon containing the nanodiamond. The nanodiamond is formed during preparation of the activated carbon. In some embodiments, the nanodiamond can be removed from the activated carbon by forming a colloidal suspension comprising the nanodiamond, and in some embodiments the nanodiamond can be concentrated by treating the activated carbon with an oxidizing agent. In some embodiments, the activated carbon can be prepared by activating a carbonaceous feedstock at a temperature in the range of about 750° C. to about 1600° C. while restricting the presence of oxygen sufficiently to result in the formation of the nanodiamond embedded in carbon. In certain embodiments, before activating the carbonaceous feedstock, the carbonaceous feedstock can be carbonized at a temperature in the range of about 500° C. to about 1600° C. while restricting the presence of oxygen.

In accordance with this method, a nanodiamond produced in various embodiments can give rise to selected area electron diffraction patterns comprised of unique reflection lines, and in various embodiments the nanodiamond is an n-diamond, a p-diamond, or an i-carbon. In many embodiments, a plurality of nanodiamonds is produced by the method. In certain embodiments, the method does not include milling or a milling step. Any embodiment of the method can be combined with any other embodiment of the method.

In another aspect, a method for producing a nanodiamond is provided that includes mixing a carbon source, a metal, and an acid under conditions leading to the formation of a nanodiamond. In some embodiments, a nanodiamond fiber is formed. In certain embodiments, the nanodiamond fiber can be up to 2000 nanometers in length, while in other embodiments the nanodiamond fiber is greater than 2000 nanometers long. In various embodiments, the nanodiamond fiber has a width in the range of about 1 to about 100 nanometers, and a thickness in the range of about 1 to about 100 nanometers.

In accordance with various embodiments of the method, the elemental carbon source comprises carbon, and in certain embodiments the elemental carbon source can comprise charred coconut shells, charred wood, coal, tar, crude oil, peat, or any combination thereof. In some embodiments, the metal comprises copper, iron, nickel, silver, gold, tin, or any combination thereof. In some embodiments, the acid provides hydrogen ions. The method can further include, in various embodiments, adding specific dopants, called “doping,” to the nanodiamond as it forms. In particular embodiments, the nanodiamond can be doped with hydrogen, silicon, nitrogen, or any combination thereof. The method also includes various embodiments in which the method is carried out at room temperature and at ambient pressure.

Further, in accordance with the method, a nanodiamond or nanodiamond fiber produced in various embodiments can give rise to a selected area electron diffraction pattern containing unique diamond reflection lines, and in various embodiments the nanodiamond or nanodiamond fiber is an n-diamond, a p-diamond, or an i-carbon diamond. In many embodiments, a plurality of nanodiamonds is produced by the method. In certain embodiments, the method does not include milling or a milling step. Any embodiment of the method can be combined with any other embodiment of the method.

In another aspect, a nanodiamond fiber is provided. In certain embodiments, the nanodiamond fiber can be up to 2000 nanometers in length, while in other embodiments the nanodiamond fiber is greater than 2000 nanometers long. In various embodiments, the nanodiamond fiber has a width and a thickness each in the range of about 1 to about 100 nanometers. A nanodiamond fiber can give rise to a selected area electron diffraction pattern containing unique diamond reflection lines in some embodiments, and can be an n-diamond, a p-diamond, or an i-carbon diamond in some embodiments. Certain embodiments include a material containing any nanodiamond fiber of the present invention. Particular embodiments include any combination of properties of any embodiment of the nanodiamond fiber as long as the properties are not mutually exclusive.

In a further aspect, a method of producing a carbon-based material is provided. In various embodiments, the method comprises obtaining a nanomaterial from an activated carbon containing the nanomaterial, wherein the nanomaterial is selected from the group consisting of a fullerene, a carbon onion and a nanotube.

The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 is a schematic representation of the generalized production of activated carbon as known to the art;

FIG. 2 is a transmission electron microscope (“TEM”) image of nanodiamonds in activated carbon; and

FIG. 3 is a TEM image of nanodiamond fibers.

### DETAILED DESCRIPTION

In one aspect, certain embodiments of the present invention result from a discovery made with regard to a method for recovering nanodiamonds, in which nanodiamonds are produced in a process entirely different from previously described nanodiamond preparation methods. In these embodiments, nanodiamonds are produced during the process of carbonization and/or activation of a carbonaceous feedstock at moderate temperature and atmospheric pressures under low-oxygen conditions, preferably through the agency of steam. The nanodiamonds form through the conversion of amorphous carbon into one or more different forms of nanodiamonds referred to as “n-diamond,” “p-diamond” and “i-carbon,” all of which being metastable forms of common cubic diamond (see, Wen, et al., “Synthesis and crystal structure of n-diamond,” International Materials Reviews, Vol 52, Issue 3, Page 131-151, hereby incorporated by reference). Other carbon-based nanomaterials, such as fullerenes, carbon onions (nanodiamonds inside fullerenes or graphite shells), and nanotubes, also form. An important condition is conducting the process of carbonization at a temperature range of at or about 800° C. to at or about 1600° C. in the absence or restriction of oxygen (preferentially by steam replacement) resulting in the production of nanodiamonds embedded in a matrix of carbon.

As used herein, the term “nanodiamond” refers to a diamond-like nanocrystal that is a metastable form of common cubic diamond. The terms “nanocrystal” and “nanomaterial” refer to a crystal or a material, respectively, having at least one dimension that is equal to or less than 1000 nanometers. Three particular types of nanodiamonds produced in accordance with methods described herein are n-diamonds, p-diamonds, and i-carbon (see, Kleiman, J.; Heimann, R. B.; Hawken, D.; Salansky, N. M. Journal of Applied Physics, Volume 56, Issue 5, Sep. 1, 1984, pp. 1440-1454 1984, herein incorporated by reference). Each of these forms is nearly as hard as cubic diamonds within a few percent, differing only in the type of dopants. Researchers hypothesize that each form of nanodiamond derives slightly different properties by incorporating into its lattice certain dopants, such as hydrogen (n-diamond), nitrogen (i-carbon), or silicon (p-diamond).

It will be recognized that the conditions described herein for conversion of carbonaceous feedstock into n-diamonds, p-diamonds, and/or i-carbon are identical to the conditions for the formation of an activated carbon. Indeed, as described herein, microscopic examination has found that commercial activated carbon contains n-diamonds, p-diamonds, and i-carbon embedded in a carbon matrix. The observation that activated carbon can be a source of nanodiamonds is believed never to have heretofore been made.

Depending on conditions, production of activated carbon can result in the formation of predominately n-diamonds, p-diamonds or i-carbon, or can result in the formation of any combination of n-diamonds, p-diamonds and/or i-carbon.

In accordance with various embodiments of the present invention, n-diamonds, p-diamonds, and/or i-carbon are recovered by concentration. In one embodiment, the embedding carbon material is processed with an oxidizing agent such as an acid or ozone to dissolve the non-diamond matrix. Alternatively or additionally, a colloidal suspension of n-diamonds, p-diamonds, and/or i-carbon can be formed, for example by processing the embedding carbon with methylene chloride, or ammonia, and then removing the colloidally suspended n-diamonds, p-diamonds, and/or i-carbon. N-diamond production ranges from 1% to 30% of the final weight of the feedstock, depending upon variations in the burn parameters, such as temperature, heating time, and cooling time.

The production of nanodiamonds from activated carbon appears to be more cost-effective than other processes by more than half. Plus, the capital equipment required for production is already in use by the activated carbon industry, meaning that production could commence soon with little capital outlay. This efficiency should greatly stimulate the nanodiamond market, which is estimated to generate more than $50 million USD in annual sales and continues to rapidly increase annually

In particular embodiments, carbonaceous feedstock is carbonized and/or activated at a temperature in the range of at or about 500° C. to at or about 1600° C. while restricting the presence of oxygen sufficiently to result in the formation of nanodiamonds and/or nanodiamond-like particles (which together can be referred to as n-diamonds, p-diamonds, and/or i-carbon) embedded in a carbon matrix. Oxygen is restricted or limited to a level such that the carbonaceous feedstock does not combust when carbonized or activated. Oxygen can be restricted by limiting air-intake while the carbonaceous feedstock is carbonized and/or activated, or by carbonizing and/or activating the carbonaceous feedstock under such substances as steam, nitrogen, or carbon dioxide, or the like. In accordance with the invention, n-diamonds, p-diamonds, and/or i-carbon are concentrated and separated from the embedding carbon. In one embodiment, the n-diamonds, p-diamonds, and/or i-carbon are concentrated by processing the carbon material containing the nanodiamonds with an oxidizing agent such as an acid or ozone. In another embodiment, the n-diamonds, p-diamonds, and/or i-carbon are removed from the carbon matrix by forming a colloidal suspension of the nanodiamonds and removing the colloidally suspended nanodiamonds. The colloidal suspension can be formed by processing the carbon matrix containing the nanodiamonds with chemicals, such as methylene chloride or ammonia.

The present invention distinguishes from Lueking et al. et al. (U.S. Patent Application Publication 20070148080) in several important aspects. Lueking et al. uses ball mills to pulverize feedstock such as coal with cyclohexene. The described method produces a milled product, and makes no suggestion that low-oxygen conditions are necessary for nanodiamond production. In contrast, various embodiments of the present invention are simpler and more economical, needing no milling, ball mills or cyclohexene. Indeed, embodiments of the present invention can use carbonaceous materials that cannot be easily milled, such as crude oil, tar, tree resins, sawdust, wood chips, shredded coconut shells, carbon black, and the like, thus demonstrating the distinct differences between the methods. In addition, in various embodiments, low-oxygen conditions are essential for the present process involving activated carbon. Moreover, Lueking et al. indicates that thermal treatment without acid/base purification produces no n-diamonds, whereas when acid treatment is used in present embodiments involving an activated carbon, it is only as an oxidizer to concentrate the n-diamonds, p-diamonds, and/or i-carbon. Whereas Lueking et al. operate at 100° C. or less, without any oxygen restriction, certain embodiments of the present invention require a temperature in the range of at or about 500° C. to at or about 1600° C. while restricting the presence of oxygen.

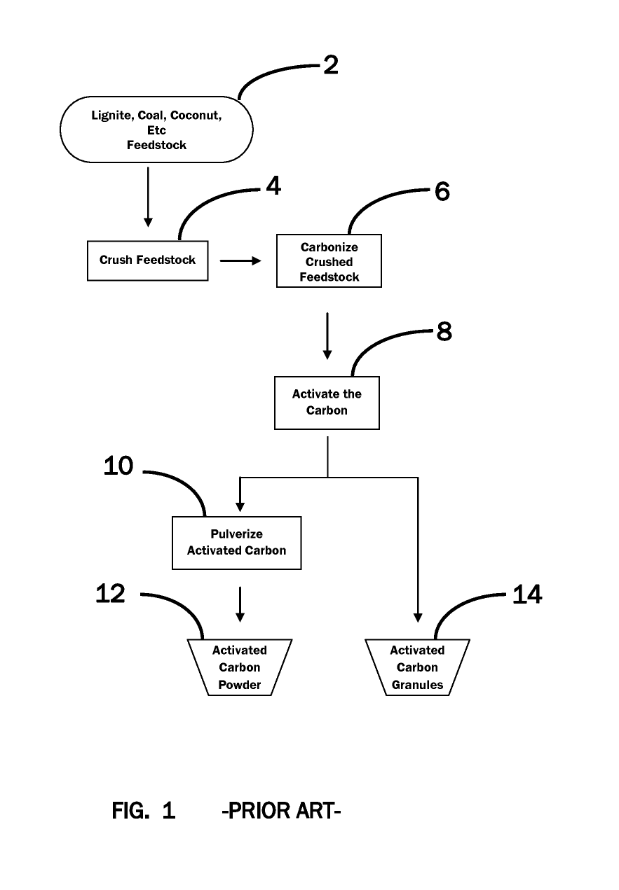

Referring to FIG. 1, during the known process of carbonization and activation of a carbonaceous feedstock at moderate temperature and atmospheric pressure, it has been discovered that spherical or rounded nanodiamonds and microdiamonds are formed through the conversion of carbon into nanodiamonds, called “new diamonds” or “n-diamonds”, p-diamonds, and i-carbon, which are metastable forms of common cubic diamond. In accordance with commercial production, lignite, coal, coconut shell, or the like carbonaceous feedstock 2 is crushed 4, carbonized 6 and activated 8. The activated carbon is pulverized 10 to form an activated carbon powder 12 or packaged directly as activated carbon granules 14.

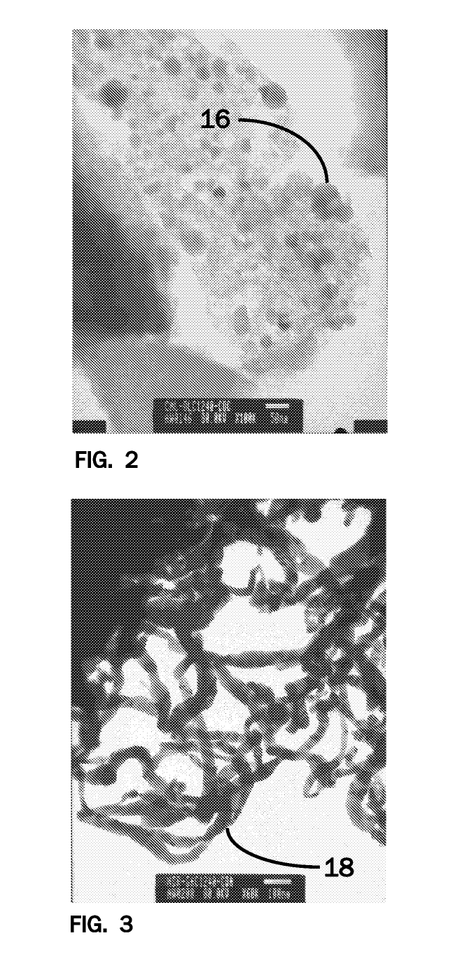

Consistent with the present invention, FIG. 2 is a transmission electron microscope (“TEM”) image of spherical and rounded nanodiamonds observed in a carbon matrix. For example, a nanodiamond 16 is identified in the figure. The activated carbon, derived from coconut shells, is from a commercial supplier (Item #OLC1240 AC; Calgon Carbon Corporation, Pittsburgh, Pa., USA, 15230). Similar results were obtained from activated carbon, derived from coal, of another commercial supplier (Item #GAC1240 AC; Norit Americas Inc., Marshall, Tex., USA, 75670).

The exact differences between n-diamonds, p-diamonds and i-carbon as compared to cubic diamonds are under intense study, though it is proposed that in n-diamonds, p-diamonds and i-carbon, non-carbon atoms are occasionally substituted for carbon atoms in the diamond lattice. The evidence for this is that for common cubic diamond, certain diffraction lines, called “forbidden” lines, such as the [200] line, do not appear in selected area electron diffraction (SAED) patterns. Diffraction patterns for the nanodiamonds described herein conclusively demonstrate that this new process produces n-diamonds, which are similar to but different than the cubic diamonds produced by detonation or by CVD.

The key parts of the production process involving activated carbon are: (1) activating a carbonaceous feedstock in a temperature range of at or about 500° C. to at or about 1600° C. in combination with (2) the absence or restriction of oxygen. The latter can be accomplished by limiting air-intake to the burn chamber or by injecting such substances as steam (the preference), nitrogen, or carbon dioxide, or by the use of some other method that prevents or limits oxidation of the carbonaceous feedstock. The low-oxygen conditions are crucial to allowing the carbonaceous feedstock to reach the temperatures necessary for conversion of carbon to nanodiamonds without combustion of the carbon feedstock. Thus, the term “low oxygen” refers to a level of oxygen that allows the carbonaceous feedstock to be carbonized and/or activated without undergoing combustion.

After production, the n-diamonds, p-diamonds, and/or i-carbon are embedded in a carbon matrix. To concentrate the nanodiamonds, the carbonized material containing the nanodiamonds can be processed with oxidizing agents, such as acids or ozone, which dissolves the feedstock and liberates the nanodiamonds. In addition, the nanodiamonds may be removed from the activated carbon and the carbon matrix by colloidal suspension, using chemicals such as methylene chloride (CH₂Cl₂) or ammonia (NH₃) to raise the pH to basic conditions, which allows the nanodiamonds to float in suspension. In some embodiments, removing the nanodiamonds from an activated carbon or carbon matrix can lead to completely purified nanodiamonds, or in other embodiments can lead to nanodiamonds that still contain some amount of contaminating activated carbon and/or carbon matrix. The nanodiamonds can be separated and/or purified from the activated carbon and the carbon matrix by processing with oxidizing agents, forming colloidal suspensions, and/or adding other purification steps known in the art, or any combination thereof. Thus, a single purification step or any combination of purification steps can be used to separate and/or purify nanodiamonds from activated carbon and carbon matrix. Currently, n-diamond production ranges from a few percent up to about 30% of the activated carbon by volume, depending upon variations in the burn parameters, such as temperature, heating time, and cooling time.

The formation of carbonized material and activated carbon is not by itself part of the invention, but carbonized/activated material forms the feedstock in which the nanodiamonds are produced. Reference can be made to U.S. Pat. No. 5,726,118 to Ivey, et al., issued Mar. 10, 1998, the disclosure of which is incorporated herein by reference. Activated carbon is a twisted network of defective carbon layer planes, cross-linked by aliphatic bridging groups. Carbonaceous materials rich in carbon are employed for the manufacture of commercial activated carbon and include coal, such as bituminous, and sub-bituminous coals, as well as lignite, wood, nut shells, peat, pitches, cokes, such as coal-based coke or petroleum-based coke, wood chips, sawdust, coconut shells, petroleum fractions, carbon black, and the like. Recent technical literature suggests other carbon materials can be converted, including automobile tires, water lilies, spent coffee grounds, waste plastics, straw, corn cobs, sewage sludge, and other solid wastes. Pelletized, extruded fiber, and impregnated forms of activated carbon can be used in addition to the powdered or granular forms.

The production process for manufacturing activated carbon generally consists of two steps: (1) carbonizing or charring and (2) activating (FIG. 1). Carbonizing occurs by subjecting the starting material to temperatures in the 500° C. to 700° C. range in the absence of oxygen, and generally conducted in vertical or horizontal rotating kilns. Activation steps vary from simple thermal treatment with an oxidizing gas such as carbon dioxide or steam or a combination of both at temperatures from about 750° C. to 1000° C. The carbonization produces a carbon skeleton possessing a latent pore structure and in the activating step, the oxidizing atmosphere greatly increases the pore volume and surface area of the product through elimination of volatile pyrolysis products. Carbon burn-off also accounts for the increases in pore volume and surface area.

In the production of activated carbon from coal such as bituminous coal or mixtures of bituminous coal and sub-bituminous coal, the process starts by forming coal briquettes, which are crushed to form a granulate. After screening, the material is thermally treated slowly in a kiln at about 450° C., for up to about eight hours, with some air to remove volatile materials and condense aromatic ring compounds in the coal. Activated carbon obtained from coconut shell does not require briquetting, oxidation, and devolatilization. Charring the coconut shell slowly prior to activation of the char produces a high activity carbon.

Activation of the granulated material obtained from this step follows by introducing it into a multi-hearth furnace at about 900° C. for about eight hours with steam and some air to effect slow controlled oxidation for drilling in the pore structure and removal of condensed aromatic rings formed in the previous step. The product is then re-screened and packaged. Typical yields of activated carbon vary from about 30 percent to about 35 percent by weight based on the coal starting material.

Among the advantages of producing nanodiamonds from activated carbon, activated carbon is widely produced, and it has been discovered that n-diamonds, p-diamonds and/or i-carbon in concentrations of several percent are present in activated carbon currently being produced by commercial suppliers (using lignite, coal, and coconut as the carbonaceous feedstock). Simple, inexpensive modifications can be made in their existing plants to produce n-diamonds, p-diamonds, and/or i-carbon. Therefore, start-up capitalization would be very low. Nearly all other newly discovered ways of producing n-diamonds require large capital outlays to build production plants. Also, most current processes of making diamonds, such as by TNT and chemical vapor deposition, cannot be easily scaled up for mass-production, making them more expensive.

Producing nanodiamonds from activated carbon is much simpler than all other known diamond productions processes. It requires no ball mills, TNT, lasers, plasmas, shock compression, chemical vaporization, substrate, or seed diamonds, all of which add to production costs. The explosive detonation of TNT is the most widely used process for diamond production, producing nanodiamonds that cost about $250,000-$1,000,000 USD/ton. By contrast, activated carbon costs about $500-$2,000 USD/ton, leading to a projected nanodiamond cost of $60,000-$125,000 USD/ton, or less than half the current cost of commercial nanodiamonds. Nanodiamond usage is growing rapidly, and a lower market price should generate a considerably larger market.

The process involving activated carbon produces single diamond crystals with a range in diameter of about 2 nanometers to about 2 micrometers, whereas most other processes yield aggregates of diamond crystals that are much larger than this (more than 4 nanometers). In certain embodiments, nanodiamonds produced in activated carbon range in size from at or about 2 nanometers to at or about 200 nanometers with the majority of single crystals ranging in size from at or about 2 nanometers to at or about 20 nanometers.

Nanodiamond is one of only a few known nanoparticles that are non-toxic when taken internally. The methods described herein produce single-crystal nanodiamonds that are typically spherical or sub-rounded (FIG. 2), making them ideal for use in medical applications. Most other nanodiamond processes produce sharp-edged diamonds that could potentially cause tissue damage. Single-crystal, spherical nanodiamonds are also better suited than sharp-edged nanodiamonds as an additive to lubricants, in which a low coefficient of friction is desirable.

In another aspect, a method for producing nanodiamonds is provided. According to this method, a carbon source, a metal and an acid are mixed together to generate nanodiamonds. Depending on conditions, nanodiamonds in the form of fibers appear to grow from a point of contact between the elemental carbon source and the metal. As used herein, the term “fiber” refers to an elongate body having one dimension (the length dimension) which is substantially greater than the other two dimensions (the transverse dimensions of width and thickness). Embodiments of the nanodiamond fiber can range from at or about 1 nanometer to at or about 100 nanometers in width and/or thickness, and more particularly, from at or about 10 nanometers to at or about 100 nanometers in width and/or thickness. Embodiments of the fibers can have a length of up to 2000 nanometers, or more, depending in part on the amount of time fibers are allowed to grow. For example, nanodiamond fibers with lengths of a meter or more may be prepared. In various embodiments, a nanodiamond fiber can have a length of more than 100 nanometers, more than 200 nanometers, more than 300 nanometers, more than 400 nanometers, more than 500 nanometers, more than 600 nanometers, more than 700 nanometers, more than 800 nanometers, more than 900 nanometers, or more than 1000 nanometers. In certain embodiments, the ratio of length to width (and/or length to thickness) can range from at or about 20:1 to at or about 200:1, or can be at least 20:1, or at least 200:1. In some embodiments, the ratio of length to width (and/or length to thickness) is at least 50:1, at least 100:1, at least 300:1, at least 400:1, at least 500:1, at least 600:1, at least 700:1, at least 800:1, at least 900:1, or at least 1000:1. A nanodiamond fiber of any length, width and thickness is contemplated. In various embodiments, a nanodiamond fiber can be straight or curved. A nanodiamond fiber 18 prepared according to this method is shown in FIG. 3.

The elemental carbon source can be any source of carbon, such as charred wood, coal, tar, crude oil, peat, and the like. In addition, the elemental carbon source can be in any form such as granular, powder, liquid, sheet, block, and the like.

It should be pointed out that nanodiamond fibers were not observed in activated carbon from commercial sources. Thus, the production of nanodiamond fibers as described herein is a novel process.

The acid may function by keeping oxygen levels low and by supplying hydrogen, both of which facilitate the production of nanodiamond fibers. Any acid that provides hydrogen ions can be used, such as hydrochloric acid, sulfuric acid, nitric acid, acetic acid, and the like. The use of different acids can facilitate the formation of different types of nanodiamond. For example, the use of nitric acid can supply nitrogen for incorporation into a nanodiamond lattice as a dopant to form i-carbon.

The metal can be any metal, such as a transition metal, an alkaline earth metal, an alkali metal, or any combination thereof. Examples of metals include, but are not limited to, copper, iron, nickel, silver, gold, and tin. The metal can be in any form such as a sheet, tube, powder, and the like.

The method for producing nanodiamond fibers can be carried out at room temperature and at ambient pressure. In other embodiments, the method can be carried out at any temperature in the range above 0° C. to below the boiling point of the acid utilized (about 100° C. to about 200° C.), with a preferred range of at or about 20° C. to at or about 200° C., or at or about 20° C. to at or about 100° C. In various embodiments, the method can be carried out at any pressure in the range of at or about 1 psi to at or about 1 GPa, with a preferred range of at or about 10 to at or about 100 psi. Any combination of temperature and pressure can be used so long as the conditions produce nanodiamonds and nanodiamond fibers.

Supplying elements such as silicon and nitrogen in ionic form with the acid can facilitate the formation of different types of nanodiamonds, e.g., the addition of silicon can form p-diamond, which can be electrically conductive, and the addition of nitrogen can form i-carbon. Thus, a nanodiamond fiber can be an n-diamond, p-diamond or i-carbon. Depending on conditions, the method can result in the formation of predominately n-diamonds, p-diamonds or i-carbon, or can result in the formation of any combination of n-diamonds, p-diamonds and i-carbon.

The density of the nanodiamonds can range from at or about 1.8 grams per cm³ to at or about 3.1 grams per cm³, comparable to other forms of industrial cubic diamonds from detonation of TNT. These values are about the density of glass fibers, but half the density of steel. Nonetheless, the diamonds are considerably harder than steel.

The nanodiamond fibers can be extracted commercially, using a known characteristic of nanodiamonds. For example, if ammonia at about pH 12 is added to the carbon-acid-diamond mixture and agitated, the diamonds become colloidally suspended. Following the decanting of the top liquid, the liquid can be evaporated leaving nanodiamonds. Alternately, by the addition of HCl to reach a pH of about 1, nearly pure diamonds will precipitate and can be collected. Alternately, any known method of extracting diamonds can be used.

The method of producing nanodiamond fibers can be carried out at room temperature and at ambient pressure. Further, the carbon source, metal and acid appear to be reusable. These features of the method provide considerable cost effectiveness and economy.

The nanodiamond fibers can be used as reinforcement materials in various industries. For example, nanodiamond fibers could be pressed or woven together, forming a high-strength diamond cloth that could be incorporated into various products, even clothing. In the automotive and aeronautical fields, nanodiamond fibers could be used as an additive to carbon composites or injection-molded plastics for increased strength. Nanodiamond fibers could also be used as an additive to ceramics for strength, and in flak jackets. Other uses in the electronics industry and pharmaceutical industry can be envisioned.

The present invention may be better understood by referring to the accompanying examples, which are intended for illustration purposes only and should not in any sense be construed as limiting the scope of the invention as defined in the claims appended hereto.

### Example 1

Charcoal was produced by burning wood from pine, oak, and ash trees. The charcoal was collected and placed inside a metal container with valves that restricted oxygen levels by allowing air out of the chamber, but not into the chamber. Valves allowed for the injection of water and gases. The container was heated at various temperatures, as follows:
1) 500° C.
2) 750° C.
3) 1000° C.
   Various interior atmospheric conditions were obtained during heating, as follows
4) low-oxygen-low-pressure conditions were obtained by preventing air from entering the chamber;
5) argon gas was injected;
6) steam was injected;
7) normal air was injected.

In this example, no diamonds formed at 500° or 750° C. (conditions 1 and 2) or in the presence of air (condition 7). However, diamonds were obtained at 1000° C. (condition 3) under all other conditions tested (conditions 4, 5, and 6). Thus, nanodiamonds formed at about 1000° C. under anoxic or low-oxygen conditions. The nanodiamonds constituted up to about 30% of the carbon by volume.

Diffraction patterns were acquired for n-diamonds that matched previously reported values, as shown in Table 1 that follows:

TABLE 1
n-diamond

| hkl | d-spacing |
|---|---|
| 111 | 2.060 |
| 200 | 1.780 |
| 220 | 1.260 |
| 311 | 1.070 |
| 222 | 1.040 |
| 400 | 0.898 |

Diffraction patterns were acquired for p-diamonds that matched previously reported values, as shown in Table 2 that follows:

TABLE 2
p-diamond

| hkl | d-spacing |
|---|---|
| 111 | 2.080 |
| 221 | 1.220 |
| 222 | 1.040 |
| 412 | 0.790 |
| 413 | 0.710 |

Diffraction patterns were acquired for i-carbon that matched previously reported values, as shown in Table 3 that follows:

TABLE 3
i-carbon

| hkl | d-spacing |
|---|---|
| 110 | 3.037 |
| 111 | 2.530 |
| 200 | 2.123 |
| 211 | 1.807 |
| 220 | 1.537 |

### Example 2

After creating nanodiamonds as in Example 1, it was realized that the process is similar to that used to create activated charcoal, which is commonly used in filtration and purification. Upon testing several types of commercial activated carbon, the presence of diamonds was observed, confirming initial experiments. It appears that activated carbon manufacturers are unaware of the presence of diamonds, which constitute up to or about 30% of the activated carbon by volume.

### Example 3

A 3-mm-wide grid for observing samples in a transmission electron microscope (TEM) was used. The grid was constructed of a thin copper support structure with about 90-micron-square holes in it, and which supported an approximately 50-nm-thick amorphous carbon film. Neither the copper nor film contained diamonds originally. Next, a drop of dilute hydrochloric acid (HCl) with a pH of 0.5 was deposited on the grid and immediately afterward, dried it at atmospheric pressure and room temperature over a span of several minutes.

Upon viewing the grid by TEM, diamonds had grown as nanometer-sized fibers at the junction of the copper and the carbon film. In some cases, the HCl had not dried completely, and in those cases, the active diamond growth process was observed by TEM. As observed, the diamonds writhed as if living, grew longer, became wider, and sometimes several fibers coalesced into one large fiber. Within a few minutes, the HCl dried and the diamond synthesis ceased. The process produced a large number of nanodiamonds on a 3-mm-wide grid within minutes.

### Example 4

Carbon dust from charred coconut shells was collected and tested to determine that it did not contain diamonds. Next, slurry was made by combining the carbon with 0.5-pH HCl. Then, a drop of the carbon-HCl solution was added to a 3-mm-wide copper grid without a carbon film. Next, the grid was allowed to dry at atmospheric pressure and room temperature over a span of several minutes.

Upon analysis of the grid by TEM, nanodiamonds were apparent as long fibers that had grown from the areas where the carbon particles had touched the copper structure. In some cases, the HCl had not dried completely, and in those cases, the active diamond growth process was observed. As observed, the diamonds writhed as if living, grew longer, became wider, and sometimes several fibers coalesced into one large fiber. Within a few minutes, the HCl dried and the diamond synthesis ceased. The process produced a large number of diamonds on a 3-mm-wide grid within minutes.

### Example 5

A nanodiamond fiber in one experiment gave a diffraction pattern characteristic of n-diamond.

Although the present invention has been described in connection with the preferred embodiments, it is to be understood that modifications and variations may be utilized without departing from the principles and scope of the invention, as those skilled in the art will readily understand. For example, variations in temperature, pressure, duration of heating and cooling, inert atmospheres, and feedstocks may lead to greater efficiencies in production. Accordingly, such modifications may be practiced within the scope of the following claims.

1. A method for producing a nanodiamond, comprising removing a nanodiamond from an activated carbon containing the nanodiamond.

2. The method of claim 1, wherein the nanodiamond is an n-diamond, a p-diamond, or an i-carbon diamond.

3. The method of claim 1, wherein the nanodiamond produces selected area electron diffraction patterns characteristic of n-diamond, p-diamond, and/or i-carbon.

4. The method of claim 1, wherein the nanodiamond is formed during preparation of the activated carbon.

5. The method of claim 1, wherein removing the nanodiamond comprises forming a colloidal suspension comprising the nanodiamond.

6. The method of claim 1, further comprising concentrating the nanodiamond by treating the activated carbon with an oxidizing agent.

7. The method of claim 1, wherein a plurality of nanodiamonds is produced by the method.

8. The method of claim 1, wherein the method does not include milling.

9. A method for producing a nanodiamond, comprising mixing a carbon source, a metal and an acid under conditions whereby to form a nanodiamond.

10. The method of claim 9, wherein the nanodiamond is in the form of a fiber.

11. The method of claim 10, wherein the nanodiamond fiber is up to 2000 nanometers long.

12. The method of claim 10, wherein the nanodiamond fiber is greater than 2000 nanometers long.

13. The method of claim 10, wherein the nanodiamond fiber is about 1 to about 100 nanometers wide, and about 1 to about 100 nanometers thick.

14. The method of claim 9, wherein the elemental carbon source comprises carbon.

15. The method of claim 9, wherein the metal comprises copper, iron, nickel, silver, gold, tin, or any combination thereof.

16. The method of claim 9, wherein the acid provides hydrogen ions.

17. The method of claim 9, wherein the nanodiamond is an n-diamond, a p-diamond, or an i-carbon diamond.

18. The method of claim 9, wherein the nanodiamond produces an electron diffraction pattern characteristic of n-diamond, p-diamond, and/or i-carbon.

19. The method of claim 9, further comprising doping the nanodiamond as it forms.

20. The method of claim 9, wherein the method is carried out at room temperature and at ambient pressure.

21. The method of claim 9, wherein a plurality of nanodiamonds is produced by the method.

22. The method of claim 9, wherein the method does not include milling.

23. A nanodiamond fiber, having a width of about 1 to about 100 nanometers and a thickness of about 1 to about 100 nanometers.

24. The nanodiamond fiber of claim 23, wherein the nanodiamond fiber is up to 2000 nanometers long.

25. The nanodiamond fiber of claim 23, wherein the nanodiamond fiber is greater than 2000 nanometers long.

26. The nanodiamond fiber of claim 23, wherein the nanodiamond fiber is an n-diamond, a p-diamond, or an i-carbon.

27. The nanodiamond fiber of claim 23, wherein the nanodiamond fiber produces an electron diffraction pattern characteristic of n-diamond, p-diamond, and/or i-carbon.

28. A material comprising the nanodiamond fiber of claim 23.

29. A method of producing a carbon-based material, comprising obtaining a nanomaterial from an activated carbon containing the nanomaterial, wherein the nanomaterial is selected from the group consisting of a fullerene, a carbon onion and a nanotube.
